(19) United States
(12) Patent Application Publication
(10) Pub. No.: US 2009/0096299 A1
(43) Pub. Date: Apr. 16, 2009

(54) ELECTROMAGNETIC EXCITER AND MANUFACTURING METHOD THEREFOR

(75) Inventors: Yoshizumi OTA, Fujiyoshida-shi (JP); Takahisa WATANABE, Fujiyoshida-shi (JP)

Correspondence Address: BRINKS HOFER GILSON & LIONE, P.O. BOX 10395, CHICAGO, IL, 60610, US

(73) Assignee: CITIZEN ELECTRONICS CO., LTD., Fujiyoshida-shi (JP)

(21) Appl. No.: 12/249,299

(22) Filed: Oct. 10, 2008

(30) Foreign Application Priority Data
Oct. 11, 2007 (JP) JP2007-265085
Nov. 30, 2007 (JP) JP2007-310249
Dec. 12, 2007 (JP) JP2007-321243
Dec. 13, 2007 (JP) JP2007-322025
Dec. 28, 2007 (JP) JP2007-339914
Jan. 22, 2008 (JP) JP2008-011169

(51) Int. Cl. H02K 33/16; H02K 15/00

(52) U.S. Cl. 310/25; 29/596

(57) ABSTRACT

A thin electromagnetic exciter has a flat casing including a casing body (2) and a cover (3), a stator (10) including an electromagnet having a coil wound around a yoke, and an oscillator (20) including a bar-shaped permanent magnet and a weight integrally attached thereto. The stator and the oscillator are disposed adjacently over a bottom wall portion (2c) of the casing body. The stator is secured to the casing body. The oscillator is vibratably supported relative to the casing body through resilient support members.

This application claims priority under 35 U.S.C. §119 to Japanese Patent application Nos. JP2007-265085 filed on Oct. 11, 2007, JP2007-310249 filed on Nov. 30, 2007, JP2007-321243 filed on Dec. 12, 2007, JP2007-322025 filed on Dec. 13, 2007, JP2007-339914 filed on Dec. 28, 2007, and JP2008-011169 filed on Jan. 22, 2008, the entire contents of which are hereby incorporated by reference.

### TECHNICAL FIELD

The present invention relates to an electromagnetic exciter that can be incorporated in thin mobile devices such as mobile phones. The present invention also relates to a method of manufacturing such an electromagnetic exciter.

### RELATED ART

Thin mobile devices such as mobile phones each generally have a vibration-generating device, e.g. an electromagnetic exciter, to inform the user of an incoming call by a beep sound or, alternatively, by vibration in trains or at meetings where noises should not be made.

Many of conventional vibration-generating devices have an eccentric rotary weight attached to a rotating shaft of a motor to generate vibration by rotating the rotary weight with the motor. A vibration-generating device having such a structure, however, has a circular cylindrical configuration as a whole and is therefore unsuitable for a reduction in thickness. Further, because the eccentric weight is rotated to generate vibration, the rotating shaft is subjected to severe stress, which gives rise to problems in terms of durability and reliability.

Japanese Patent Application Publication No. 2002-143770 proposes a transverse vibration-type electromagnetic exciter that enables a reduction in thickness as compared to the above-described cylindrical vibration-generating device. The electromagnetic exciter has a terminal-mounted base, a stator secured to the terminal-equipped base, and an oscillator disposed over the stator. The stator has a yoke wound with a coil. The oscillator has a permanent magnet having a weight integrally attached to the permanent magnet. The oscillator is vibratably supported relative to the terminal-mounted base through a resilient support member.

The above-described electromagnetic exciter transversely vibrates the oscillator having a permanent magnet by the action of alternating magnetic poles generated in the yoke by applying a current drive signal of a predetermined frequency to the coil of the stator.

The above-described electromagnetic exciter suffers, however, from the following problem. The stator and the oscillator are stacked over the terminal-equipped base in the direction of the height of the electromagnetic exciter. Consequently, the height of the electromagnetic exciter increases, which hinders reduction in thickness of a mobile device into which the electromagnetic exciter is incorporated.

### SUMMARY OF THE INVENTION

The present invention has been made in view of the above-described problem. Accordingly, an object of the present invention is to provide an electromagnetic exciter that vibrates transversely and enables reduction in thickness of a mobile device into which the electromagnetic exciter is incorporated. Another object of the present invention is to provide a method of manufacturing the electromagnetic exciter.

The present invention provides an electromagnetic exciter including a casing having a flat bottom wall portion, and a stator having an electromagnet comprising a yoke and a coil wound around the yoke. The stator is secured to the bottom wall portion of the casing body. The electromagnetic exciter further includes an oscillator having a permanent magnet and a weight attached to the permanent magnet, and at least one resilient support member vibratably supporting the oscillator relative to the casing. The oscillator faces the bottom wall portion of the casing substantially parallel to a length direction of the casing and extends substantially parallel to the stator. The oscillator is vibrated by an alternating magnetic field generated by application of an alternating current drive signal to the coil of the stator.

With the above-described structure, the electromagnetic exciter can be flattened as a whole. Accordingly, the electromagnetic exciter is suitable for reducing the thickness of devices such as mobiles phones into which it may be incorporated.

Specifically, the casing may comprise a casing body having the bottom wall portion and a cover fitted to the casing body.

The at least one resilient support member may include two resilient support members that support the opposite ends, respectively, of the oscillator.

Specifically, the casing body may have a side wall, and the two resilient support members may be spring members each secured to the side wall of the casing body.

The arrangement may be as follows. The casing body is made of a metal and has a side wall. The spring members comprise two elongated metal plates extending from the opposite ends, respectively, of the side wall of the casing body. The metal plates are serpentined inside the casing, respectively. With this structure, the number of component parts can be reduced, and the assembling operation is facilitated.

The oscillator may have a support plate that supports the oscillator. The support plate may be supported, substantially parallel to a length direction of the bottom wall portion of the casing, by the resilient support members. The use of the support plate facilitates the assembly of the magnet and the permanent magnet.

Specifically, the oscillator may have an adhesive layer disposed between the permanent magnet and the weight, and the support plate. More specifically, the oscillator may have an adhesive sheet disposed on the support plate and the permanent magnet and the weight are disposed on the adhesive sheet to fix the permanent magnet and the weight to the support plate. The use of such an adhesive layer or an adhesive sheet facilitates the assembly of the oscillator. Even if the permanent magnet or the weight breaks, the configuration thereof can be retained by the adhesive layer or sheet, and the function of the electromagnetic exciter can be maintained.

The arrangement may be as follows. The casing is made from a metal and has a side wall. The at least one resilient support member includes a pair of spring members comprising a pair of strips extending from the opposite ends of the side wall of the casing. The strips are serpentined inside the casing, respectively. The pair of spring members are connected to the opposite ends, respectively, of the support plate of the oscillator to support the oscillator.

The arrangement may be as follows. The cover has a side wall. The spring members extend from the opposite ends, respectively, of the side wall of the casing body. The spring members are fixed to the side wall of the cover at respective positions away from the opposite distal ends of the strips. The effective length of each of the spring members is defined by the length from the respective position to the distal end thereof. With this structure, it becomes easy to adjust the effective length of the spring members.

The permanent magnet and the weight are preferably arranged to constitute a single plate structure substantially parallel to a length direction of the bottom wall portion of the casing. This is for reducing the thickness of the oscillator.

The arrangement may be as follows. The yoke has a bar shape and is set parallel to a length direction of the bottom wall portion of the casing. The coil of the stator has a first coil portion wound around the yoke at one side of a central portion of the yoke and a second coil portion wound around the yoke at the other side of the central portion. The yoke has magnetic pole portions at the central portion and end portions thereof. The magnetic pole portions at the end portions are arranged to generate the same magnetic pole, and the magnetic pole portion at the central portion is arranged to generate a magnetic pole opposite in polarity to the magnetic pole generated in the magnetic pole portions at the end portions. The permanent magnet has a first permanent magnet and a second permanent magnet connected together in a straight line. The first and second permanent magnets face the first and second coil portions, respectively, substantially parallel to the first and second coil portions. The first and second permanent magnets have magnetic poles opposite in polarity to each other at their surfaces facing the first and second coil portions, respectively.

In addition, the present invention provides a method of manufacturing an electromagnetic exciter that includes a casing having a flat bottom wall portion and a stator having an electromagnet comprising a yoke and a coil wound around the yoke. The stator is secured to the bottom wall portion of the casing body. The electromagnetic exciter further includes an oscillator having a permanent magnet, and a weight attached to the permanent magnet, and at least one resilient support member supporting the oscillator vibratoly relative to the casing body. The oscillator faces the bottom wall portion of the casing substantially parallel to a length direction of the casing body and extends substantially parallel to the stator. The method includes an unfolded casing body blank forming step of forming an unfolded casing body blank having the shape of the casing body as unfolded. The unfolded casing body blank is formed in each of openings formed in a strip material at predetermined intervals. The unfolded casing body blank is supported by connecting strips extending inward of the opening from the peripheral edge thereof. The method further includes a casing body forming step of forming the casing body in the shape of a tray by folding the outer peripheral portions of the unfolded casing body blank to form the bottom wall portion and side wall portions surrounding the bottom wall portion. Further, the method includes an oscillator disposing step of disposing the oscillator in the casing body substantially parallel to a length direction of the bottom wall portion of the casing body at a distance from the bottom wall portion. The oscillator is vibratably supported by the at least one resilient support member. The method further includes a stator-disposing step of disposing and securing the stator to the bottom wall portion of the casing body substantially parallel to the oscillator. Further, the method includes a casing forming step of fitting and securing a cover to the casing body having the stator and the oscillator disposed therein to complete the electromagnetic exciter, and a cutting step of cutting off the connecting strips to separate the electromagnetic exciter from the strip material.

The above-described method makes it possible to form a casing body and to incorporate an oscillator and other components into the casing body while continuously feeding a strip material. Accordingly, the electromagnetic exciter can be produced efficiently.

Specifically, the cover may be formed by blanking a plate material into an unfolded cover blank having the shape of the cover as unfolded in a plane and folding the outer peripheral portions of the unfolded cover blank to form a top wall portion and side wall portions surrounding the top wall portion. The cover may be fitted and secured to the casing body with the side wall portions thereof contacting the side wall portions of the casing body.

The method may be carried out as follows. In the unfolded casing body blank forming step, the unfolded casing body blank is formed with a pair of strip portions extending from the opposite ends, respectively, of an outer peripheral edge portion of the unfolded casing body blank that is to form one of the side wall portions of the casing body. The pair of strip portions are serpentined inwardly to form a pair of resilient support members. In the oscillator-disposing step, the distal end portions of the pair of resilient support members are fixed to the opposite ends, respectively, of the oscillator to support the oscillator. By so doing, the number of component parts is reduced, and the assembly of the parts is facilitated.

The method may be carried out as follows. In the unfolded casing body blank forming step, first through-holes for positioning the stator are formed in a portion of the unfolded casing body blank that is to form the bottom wall portion of the casing body. In the casing body forming step, pins are fitted and secured into the through-holes, respectively. In the stator-disposing step, the pins are fitted into through-holes for positioning provided in the stator to position the stator relative to the bottom wall portion of the casing body. In the casing forming step, the pins are fitted into second through-holes for positioning the stator, and the pins are provided in the cover, to secure the stator between the casing body and the cover. The use of pins facilitates the positioning of the stator. Even if an impact is applied to the electromagnetic exciter during use due, for example, to a fall, the stator can be prevented from being displaced. Thus, the reliability of the electromagnetic exciter can be increased.

The method may be carried out as follows. In the unfolded casing body blank forming step, a plurality of snap-engaging portions are formed in portions of the unfolded casing body blank that are to form the side wall portions of the casing body. In the casing forming step, the snap-engaging portions are engaged with snap-engaging portions formed on the side wall portions of the cover to secure the casing body and the cover to each other. By so doing, the mounting of the cover is facilitated.

The oscillator may have a permanent magnet, a magnetic member and a weight of a high specific gravity material disposed on a single support plate in close contact with each other in a plane to form a plate-shaped structure as a whole. With this arrangement, the oscillator can be reduced in thickness, and it is possible to form a magnetic circuit having a reduced reluctance.

The arrangement may be as follows. The yoke has a bar shape. The coil has a first coil portion wound around an end portion of the yoke at one side of a central portion of the yoke and a second coil portion wound around an end portion of the yoke at the other side of the central portion. The yoke has magnetic pole portions at the central and end portions thereof. The magnetic pole portions at the end portions are arranged to generate the same magnetic pole. The magnetic pole portion at the central portion is arranged to generate a magnetic pole opposite in polarity to the magnetic pole generated in the magnetic pole portions at the end portions. The permanent magnet has a first permanent magnet and a second permanent magnet connected together in a straight line. The first and second permanent magnets face the first and second coil portions, respectively, substantially parallel thereto. The first and second permanent magnets have magnetic poles opposite in polarity to each other at their surfaces facing the first and second coil portions, respectively. In this case, the coil may be formed by winding a single wire, and the first and second coil portions may be opposite in winding direction but equal to each other in the number of turns of the wire. Because the two coil portions are formed by using a single wire, the making of the coil is facilitated, and the circuit for applying an alternating voltage can be simplified.

In addition, the present invention provides a method of manufacturing an electromagnetic exciter that has a flat casing including a casing body having a flat bottom wall portion and a cover fitted to the casing body and that has a stator having an electromagnet comprising a yoke and a coil wound around the yoke. The stator is secured to the bottom wall portion of the casing body. The electromagnetic exciter further has an oscillator having a permanent magnet and a weight attached to the permanent magnet, and at least one spring member extending from the casing body to support the oscillator vibratably relative to the casing body. The oscillator faces the bottom wall portion of the casing body substantially parallel to a length direction of the casing body and extends substantially parallel to the stator. The method includes the step of determining a spring constant of the at least one spring member so that the natural frequency of a vibration system comprising the at least one spring member and the oscillator in a state where the oscillator is supported by the at least one spring member is lower than the frequency of an alternating driving signal applied to the electromagnet of the electromagnetic exciter. The method further includes the steps of measuring the natural frequency of the vibration system comprising the at least one spring member and the oscillator; comparing the natural frequency measured to the frequency of the alternating driving signal applied to the electromagnet to determine a length of the spring member necessary to make the natural frequency substantially equal to the frequency of the alternating current drive signal; and making an adjustment to make the effective length of the spring member of the vibration system, equal to the length of the spring member, the length necessary by fixing, to the cover at a position of the spring member apart from a distal end of the spring member.

The above-described method enables the natural frequency and the alternating current drive signal frequency to be easily adjusted to be substantially the same and hence makes it easy to produce an electromagnetic exciter having high vibration efficiency.

Specifically, the at least one spring member may include a pair of spring members extending from the opposite ends, respectively, of one of the side wall portions of the casing body, the pair of spring members supporting the oscillator at the distal ends thereof.

### BRIEF DESCRIPTION OF THE DRAWINGS

FIG. 1 is a perspective view of an electromagnetic exciter according to a first embodiment of the present invention.

FIG. 2 is a top plan view showing the electromagnetic exciter in FIG. 1 with a cover removed therefrom.

FIG. 3 is a sectional view taken along the line III-III in FIG. 2.

FIG. 4 is a sectional view taken along the line IV-IV in FIG. 2.

FIG. 5 is a developed view of a casing body in the first embodiment of the present invention.

FIG. 6 is a developed view of a cover in the first embodiment of the present invention.

FIG. 7 is a diagram showing a coil unit in the first embodiment of the present invention, of which: part (a) is a perspective view of a yoke of the coil unit; and part (b) is a perspective view of the coil unit.

FIG. 8 is a perspective view of a coil unit and a flexible printed circuit board (FPC), which constitute a stator in the first embodiment of the present invention.

FIG. 9 is a top plan view of the stator shown in FIG. 8.

FIG. 10 is a side view of the stator shown in FIG. 8.

FIG. 11 is an exploded perspective view of an oscillator in the first embodiment of the present invention.

FIG. 12 is a perspective view of the oscillator in the first embodiment of the present invention.

FIG. 13 is a sectional view taken along the line XIII-XIII in FIG. 12, showing the oscillator.

FIG. 14 is a perspective view showing the stator and the oscillator to explain the driving operation of the electromagnetic exciter in the first embodiment of the present invention.

FIG. 15 is a perspective view showing the stator and the oscillator to explain the driving operation of the electromagnetic exciter in the first embodiment of the present invention.

FIG. 16 is a perspective view of an oscillator in a second embodiment of the present invention.

FIG. 17 is a perspective view of an oscillator in a third embodiment of the present invention.

FIG. 18 is a perspective view of the cover and casing body of the electromagnetic exciter according to the first embodiment of the present invention.

FIG. 19 is a diagram for explaining an electromagnetic exciter manufacturing method according to an embodiment of the present invention.

FIG. 20 is a diagram for explaining an unfolded casing body blank forming step in the electromagnetic exciter manufacturing method.

FIG. 21 is a diagram for explaining a casing body forming step in the electromagnetic exciter manufacturing method.

FIG. 22 is a diagram for explaining the step of disposing the oscillator in the casing body in the electromagnetic exciter manufacturing method.

FIG. 23 is a diagram showing the way in which the oscillator is disposed in the casing body in the electromagnetic exciter manufacturing method, of which: part (a) is a plan view; and part (b) is a sectional view taken along the line 23B-23B in part (a) of FIG. 23.

FIG. 24 is a diagram showing the structure of FIG. 23, of which: part (a) is an enlarged view of a part enclosed in the circle 24A in part (a) of FIG. 23; and part (b) is an enlarged view of a part enclosed in the circle 24B in part (b) of FIG. 23.

FIG. 25 is an exploded perspective view of the oscillator.

FIG. 26 is a perspective view of the oscillator.

FIG. 27 is a diagram for explaining a coil unit in the electromagnetic exciter manufacturing method, of which: part (a) is a perspective view of a yoke of the coil unit; and part (b) is a perspective view of the coil unit.

FIG. 28 is a top plan view of the stator.

FIG. 29 is a plan view of a flexible printed circuit board (FPC) constituting the stator block.

FIG. 30 is a diagram for explaining the step of fitting the stator.

FIG. 31 is a diagram showing the way in which the stator is disposed in the casing body, of which: part (a) is a top plan view; part (b) is a fragmentary enlarged view of a part enclosed in the circle 31B in part (a) of FIG. 31; and part (c) is a fragmentary enlarged view of a part enclosed in the circle 31C in part (a) of FIG. 31.

FIG. 32 is a diagram for explaining the step of fitting and securing the cover to the casing body to form a casing in the electromagnetic exciter manufacturing method of the present invention.

FIG. 33 is a fragmentary sectional view taken along the line 33-33 in FIG. 32.

FIG. 34 is a fragmentary sectional view taken along the line 34-34 in FIG. 32.

FIG. 35 is a diagram for explaining the unfolded cover blank forming step.

FIG. 36 is a perspective view showing an electromagnetic exciter produced by the electromagnetic exciter manufacturing method.

FIG. 37 is a top plan view showing the electromagnetic exciter in FIG. 36 with the cover removed therefrom.

FIG. 38 is a sectional view taken along the line 38-38 in FIG. 37, showing the electromagnetic exciter.

FIG. 39 is a sectional view taken along the line 39-39 in FIG. 37, showing the electromagnetic exciter.

### DETAILED DESCRIPTION OF THE INVENTION

Embodiments of the present invention will be explained below with reference to the accompanying drawings.

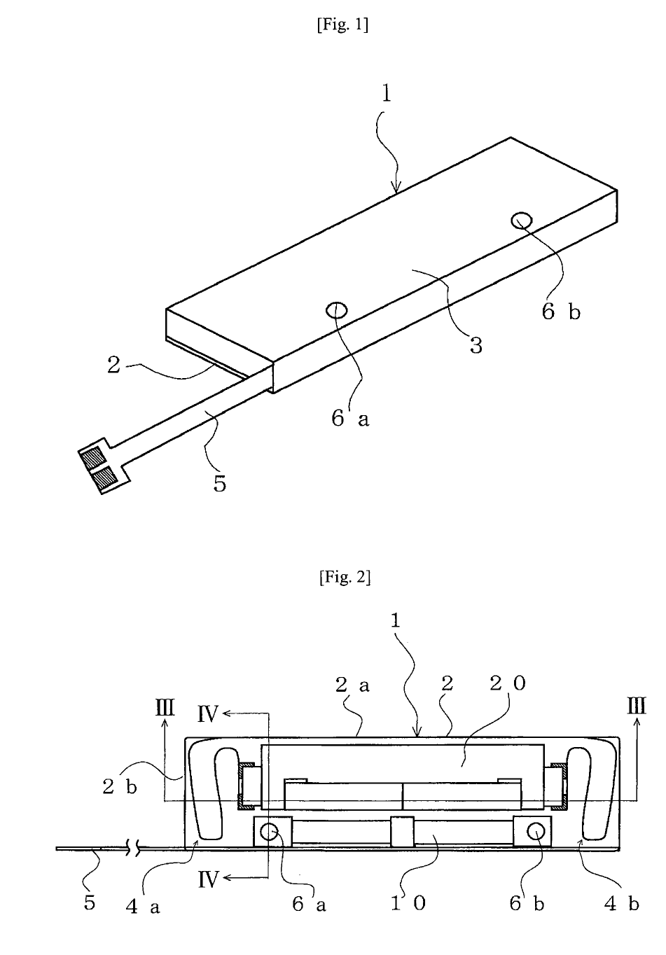

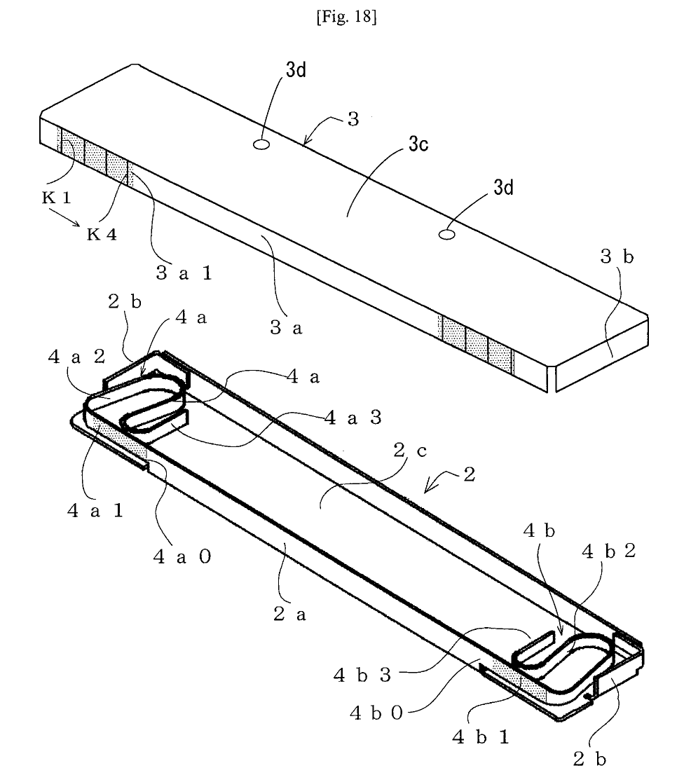

In FIG. 1, an electromagnetic exciter 1 according to a first embodiment of the present invention has an electromagnetic exciter main body (described later) housed in a flat casing comprising a casing body 2 and a cover 3 (see FIG. 18), which is described later. A flexible printed circuit board (FPC) 5 for connection with an external circuit is led out from one end of the electromagnetic exciter 1. It should be noted that the casing may be a substantially box-shaped casing having a substantially flat plate integrally formed therewith to close the top thereof.

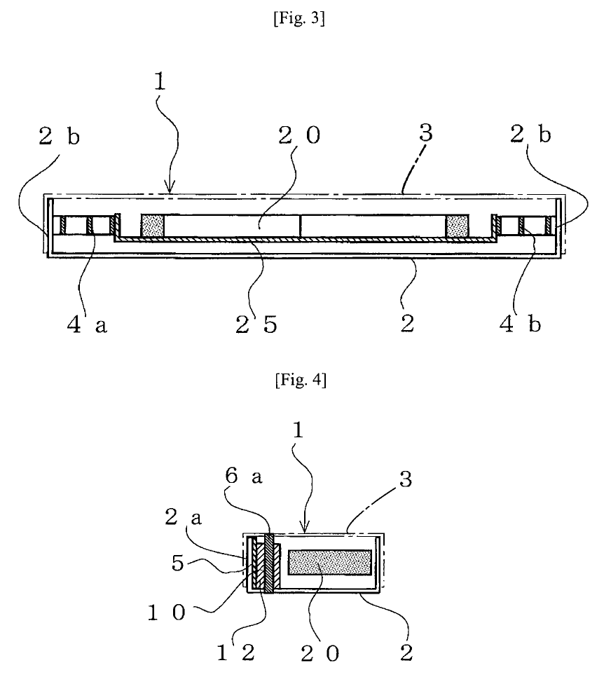

FIG. 2 is a top plan view showing the electromagnetic exciter 1 in FIG. 1 with the cover 3 removed therefrom to allow the main body part of the electromagnetic exciter 1 to be seen. In the exciter 1, a stator 10 and an oscillator 20 are disposed adjacently in parallel to long-side wall portions 2a of a rectangular casing body 2. The stator 10 is secured between the casing body 2 and the cover 3 with two pins 6a and 6b extending through a yoke 12 constituting the stator 10. The oscillator 20 is floatingly supported (see FIGS. 2 to 4) in the casing body 2 by two spring members (resilient support members) 4a and 4b formed as parts of the casing body 2 as described later.

FIG. 6 shows a cover 3 before being subjected to forming process. The cover 3 is formed by blanking a metal plate. The cover 3 as shown in FIG. 6 is folded along the dotted lines into a cover 3 having, as shown in FIG. 18, a top wall portion 3c, long-side wall portions 3a and short-side wall portions 3b. The top wall portion 3c is provided with two holes 3d for securing pins 6a and 6b as shown in FIG. 4.

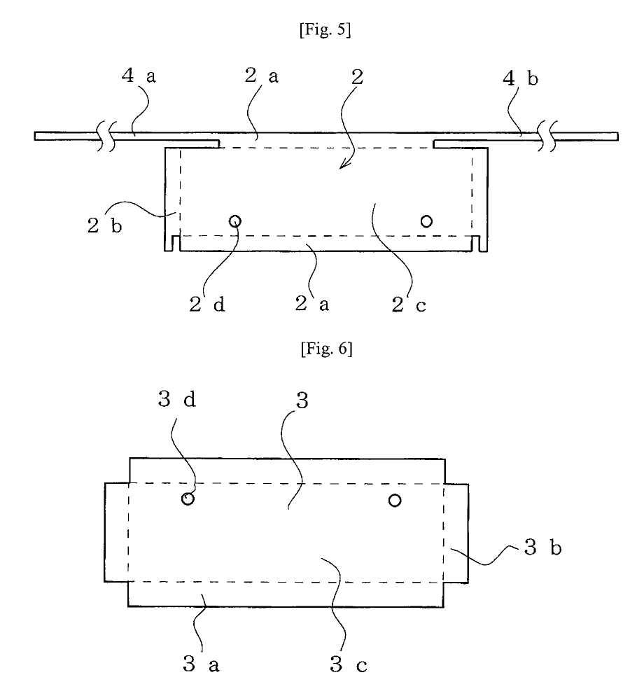

FIG. 5 shows a casing body 2 before being subjected to forming process (i.e. an unfolded casing body blank). The casing body 2 is formed by blanking a metal plate. The casing body 2 as shown in FIG. 5 is folded along the dotted lines into a casing body 2 having, as shown in FIG. 18, a bottom wall portion 2c, long-side wall portions 2a and short-side wall portions 2b. The bottom wall portion 2c is provided with two holes 2d for securing the pins 6a and 6b as shown in FIG. 4. The above-described spring members 4a and 4b are two bended and elongated metal plates extending from two opposite ends of one long-side wall portion 2a. The spring members 4a and 4b respectively have, as shown in FIG. 18, spring constant adjusting portions 4a1 and 4b1 (shown in halftone) extending from joints 4a0 and 4b0 with the long-side wall portion 2a, spring portions 4a2 and 4b2 following the spring constant adjusting portions 4a1 and 4b1 and serpentined from near the corresponding short-side wall portions 2b, and fixed portions 4a3 and 4b3 that are fixed to the oscillator 20. The cover 3 has a spring constant adjusting portion 3a1 (shown in halftone) defined at a position on one long-side wall portion 3a thereof that corresponds to the spring constant adjusting portion 4a1 of the casing body 2 when the cover 3 is fitted to the casing body 2. The spring constant adjusting portions 3a1 and 4a1 are in contact with each other and fixed together at an appropriate position. The position where the two spring constant adjusting portions 3a1 and 4a1 are fixed to each other is determined to determine a natural frequency of the vibration system comprising the oscillator 20.

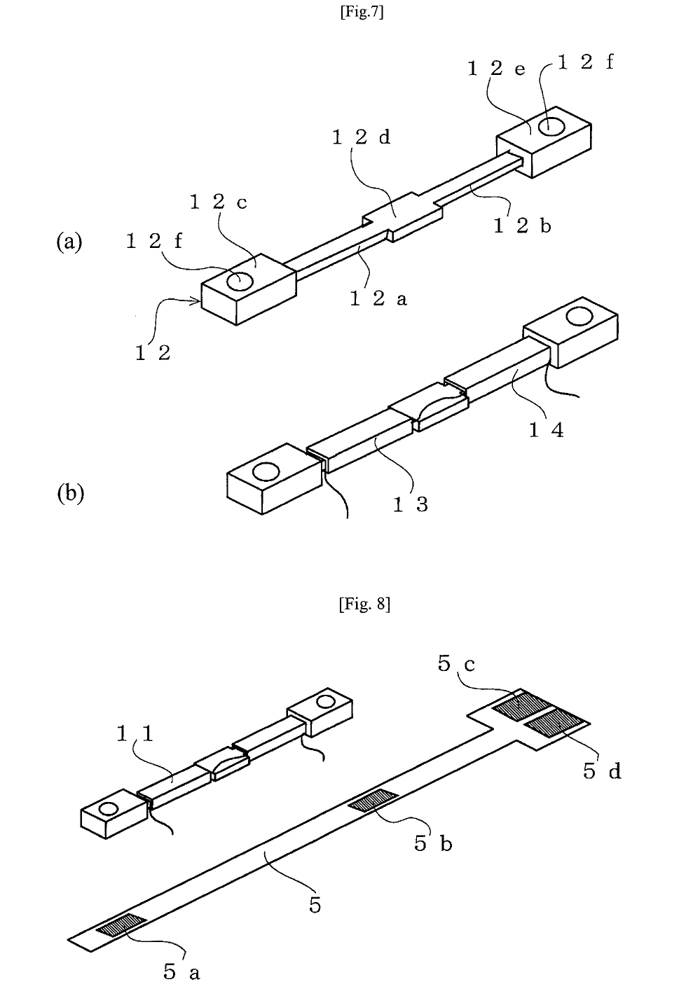

In FIG. 7, part (b) shows a coil unit 11 constituting the stator 10, and part (a) shows a yoke 12 of the coil unit 11. The yoke 12 has two winding portions 12a and 12b wound with coils 13 and 14, respectively, and three magnetic pole portions 12c, 12d and 12e. The magnetic pole portions 12c and 12e at the opposite ends of the yoke 12 are provided with securing holes 12f, respectively. The coils 13 and 14 are opposite in winding direction but equal to each other in the number of turns of the coil wire. In this embodiment, the two coils 13 and 14 are formed from a single coil wire. After the coil wire has been wound around the winding portion 12a of the yoke 12 to form the coil 13, the coil wire is extended across the magnetic pole portion 12d and wound around the winding portion 12b to form the coil 14.

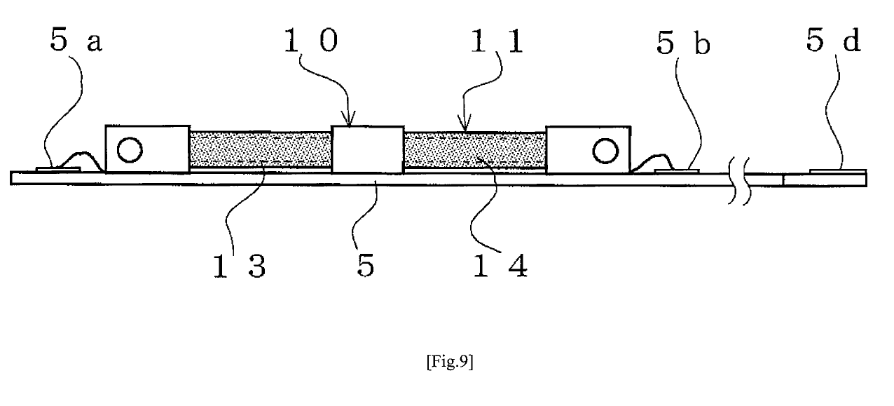

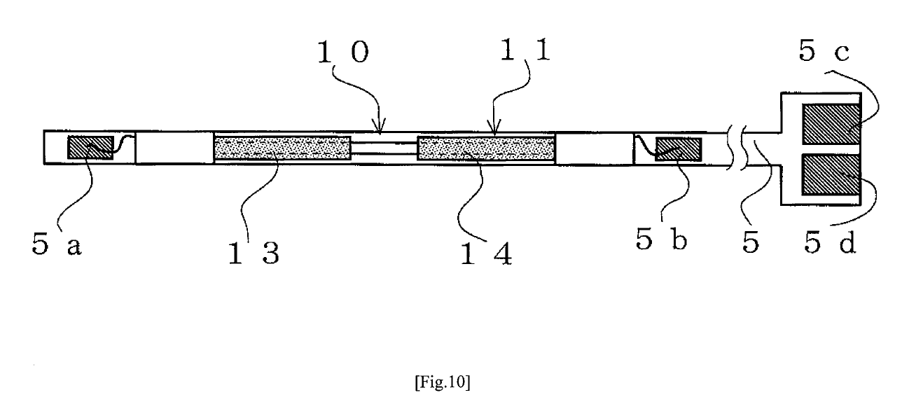

As shown in FIG. 8, the FPC (flexible printed circuit board) 5 has two connecting electrodes 5a and 5b on a mount surface thereof where the coil unit 11 is secured. The connection electrodes 5a and 5b are used to electrically conductively bond the terminal lead wires of the coils 13 and 14. The FPC 5 further has external-connection electrodes 5c and 5d on the mount surface thereof. The external-connection electrodes 5c and 5d are used for external connection. As shown in FIGS. 9 and 10, the coil unit 11 is secured to the mount surface of the FPC 5 with a double-sided adhesive sheet or the like, and the terminal lead wires of the coils 13 and 14 are soldered to the connection electrodes 5a and 5b, respectively. As a result, the terminal lead wires of the coils 13 and 14 are electrically connected to the external-connection electrodes 5c and 5d, respectively. The stator 10 comprises the coil unit 11 and the FPC 5.

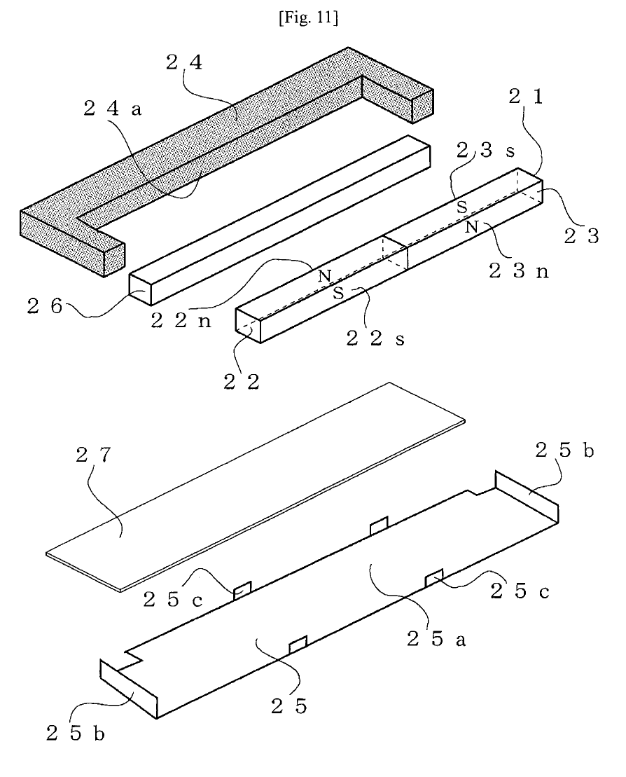

As shown in FIG. 11, the oscillator 20 has a permanent magnet 21, a magnetic member 26 of substantially the same shape and size as the permanent magnet 21, a weight 24 having a recess 24a for accommodating the permanent magnet 21 and the magnetic member 26, a support plate 25, and an adhesive sheet 27 for fixedly bonding the permanent magnet 21, the magnetic member 26 and the weight 24 to the support plate 25. The adhesive sheet 27 is disposed on the support plate 25, and the permanent magnet 21, the magnetic member 26 and the weight 24 are disposed on the support member 25. The permanent magnet 21 is a rectangular parallelepiped permanent magnet comprising two bar-shaped permanent magnets 22 and 23 fixed to each other. Each bar-shaped permanent magnet 22 (23) has a magnetic pole 22s (23n) on a long-side surface thereof facing the stator 10 (i.e. the surface on the front side as viewed in FIG. 11) and a magnetic pole 22n (23s) on the opposite side surface. That is, the bar-shaped permanent magnets 22 and 23 have been magnetized in the opposite directions to each other. The weight 24, the permanent magnet 21 and the magnetic member 26 have substantially a same thickness. The support plate 25 has a rectangular securing surface 25a, mounting portions 25b along the short sides of the securing surface 25a, and two positioning portions 25c on each long side of the securing surface 25a. The adhesive sheet 27 has substantially a same shape as that of the securing surface 25a of the support plate 25. An adhesive layer may be provided in place of the adhesive sheet 27.

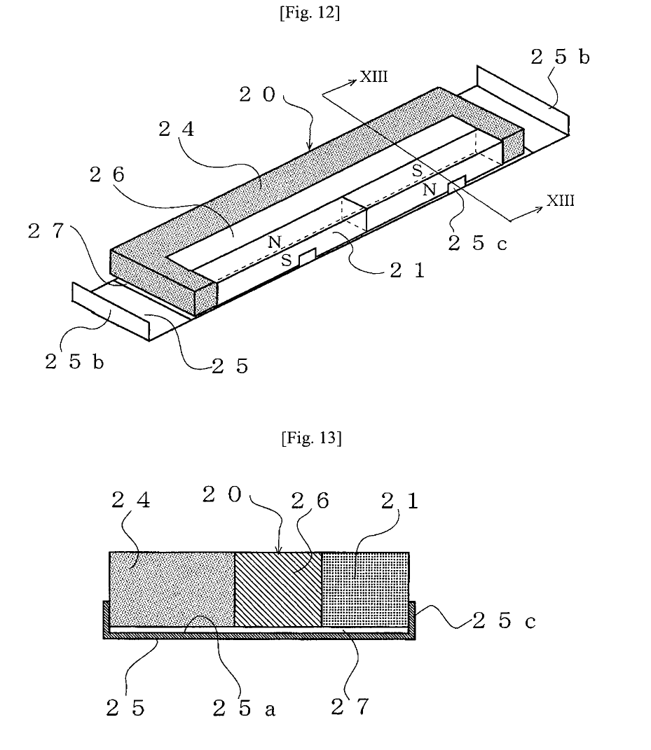

The positioning portions 25c of the support plate 25 enable the permanent magnet 21, the magnetic member 26 and the weight 24 to be accurately mounted with respect to the support plate 25. As shown in FIGS. 12 and 13, the permanent magnet 21, the magnetic member 26 and the weight 24 are united together into a single plate structure.

The oscillator 20 needs to be excellent in magnetic characteristics in order to increase driving force for the oscillator 20 to vibrate and also needs to be heavy in weight in order to increase the vibration output. For this reason, in this embodiment, the permanent magnet 21 is made of a neodymium sintered alloy excellent in magnetic characteristics and having a relatively high specific gravity of 7.4. The weight 24 is made of a tungsten alloy having a specific gravity of 15 to 18, which is a high specific gravity material. The magnetic member 26 is made of an SPCC (mild iron or steel) also having a relatively high specific gravity of 7.85.

As has been stated above, the oscillator 20 in the present invention is made less costly by using magnetic materials of a relatively high specific gravity to form the permanent magnet 21 and the magnetic member 26, resulting in reduction of the amount of use of a tungsten alloy, which is a costly, high specific gravity material, without substantially reducing the overall weight. The neodymium sintered alloy and the tungsten alloy are brittle materials and easily broken by an impact applied thereto upon a fall of the associated portable device, for example. In this embodiment, the permanent magnet 21 and the weight 24, which are made of these materials, are bonded to the support plate 25 by using the adhesive sheet 27. By imparting shock-absorbing properties to the adhesive sheet 27, the possibility of breakage due to an impact can be reduced. Even if the permanent magnet 21 or the weight 24 breaks, the overall configuration thereof can be retained.

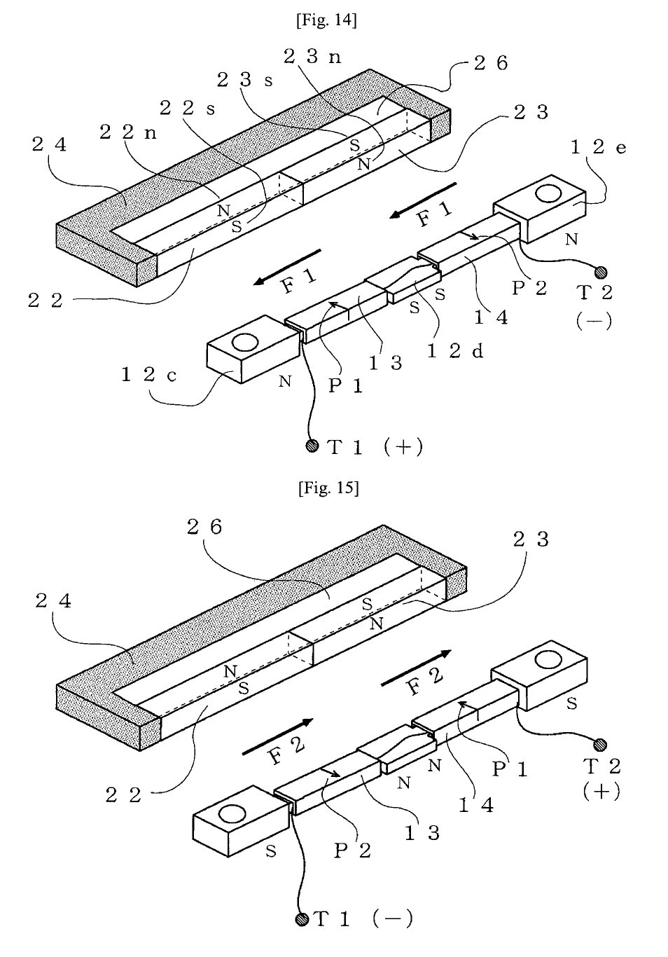

FIGS. 14 and 15 are diagrams for explaining the driving operation of the electromagnetic exciter 1. FIGS. 14 and 15 show two different states of the electromagnetic exciter 1 in which the directions of an electric current flowing through the coils 13 and 14 are opposite to each other.

When no driving signal is supplied between a terminal T1 connected to the terminal of the coil 13 (in actuality, the terminal T1 is connected to the external-connection electrode 5c) and a terminal T2 connected to the terminal of the coil 14 (in actuality, the terminal T2 is connected to the external-connection electrode 5d), magnetic attraction forces are acting between the magnetic pole 22s of the permanent magnet 22 and the magnetic pole portions 12c and 12d of the yoke 12 and between the magnetic pole 23n of the permanent magnet 23 and the magnetic pole portions 12d and 12e of the yoke 12. Accordingly, the oscillator 20 is at rest.

When a driving signal (alternating driving voltage) is supplied through the terminals T1 and T2 to the coils 13 and 14, that are wound in opposite directions to each other, and an electric current flows as shown in FIG. 14, a north pole is generated in each of the magnetic pole portions 12c and 12e and a south pole in the magnetic pole portion 12d. Consequently, the magnetic pole surfaces 22s and 23n of the oscillator 20, which face the stator 10, receive magnetic attraction and repulsion forces from the magnetic pole portions 12c, 12e and 12d, respectively. Accordingly, the oscillator 20 receives driving forces shown by reference symbol F1 in FIG. 14.

When the direction of the electric current is reversed as shown in FIG. 15, a south pole is generated in each of the magnetic pole portions 12c and 12e and a north pole in the magnetic pole portion 12d. Consequently, the oscillator 20 receives driving forces F2 in the opposite direction to that in FIG. 14.

In response to the alternating driving signal applied as stated above, the oscillator 20 alternately receives driving forces in the opposite directions to each other and thus vibrates. The vibration is transmitted to the outside through the casing comprising the casing body 2 and the cover 3.

It is important in the electromagnetic exciter according to the present invention that the oscillator should vibrate efficiently. In order for the oscillator to vibrate most efficiently, the vibration system of the oscillator should have a natural frequency that is the same as the frequency of the alternating driving signal. Therefore, this embodiment adopts the following scheme. As shown in FIG. 18, four selectable fixing positions K1 to K4 are predetermined for each of the spring constant adjusting portions 4a1 and 4b1 of the spring members 4a and 4b, and the spring constant adjusting portions 4a1 and 4b1 are each fixed to the corresponding spring constant adjusting portion 3a1 of the cover 3 at one of the four positions K1 to K4, and thus, the effective length of each of the spring members 4a and 4b from the fixed position to the distal end thereof is determined, and the vibration system of the oscillator has a natural frequency close to the frequency of the alternating current drive signal. Specifically, this scheme is performed as follows.

A driving signal is experimentally applied to the electromagnetic exciter 1 before the above-described fixing is performed at the spring constant adjusting portions 4a1 and 4b1 of the spring members 4a and 4b. The driving signal is applied to the electromagnetic exciter 1 with its frequency being continuously changed to find a frequency at which the oscillator 20 is resonantly driven. The spring member 4a (4b) at this time has an effective length predetermined so that the natural frequency of the vibration system of the oscillator 20 is lower than the frequency of the alternating driving signal designed for the electromagnetic exciter 1. The natural frequency of the vibration system of the oscillator 20 varies according to the variation of machined configuration of the spring member 4a (4b) and also according to the variation of weight of the oscillator 20 and further according to the variation of fixing condition of the spring member 4a (4b) and the oscillator 20.

In view of the frequency at which the oscillator 20 is resonantly driven, which is found as stated above, the effective length of the spring member 4a (4b) is adjusted to make the natural frequency of the vibration system of the oscillator 20 close to the frequency of the alternating driving signal designed for the electromagnetic exciter 1. In the illustrated embodiment, four selectable fixing positions K1 to K4 are predetermined for each of the spring constant adjusting portions 4a1 and 4b1 of the spring members 4a and 4b, and one of the fixing positions K1 to K4 is selected. At the selected fixing position, the head of a laser welding machine is set through an opening (not shown) provided in the casing to perform spot welding.

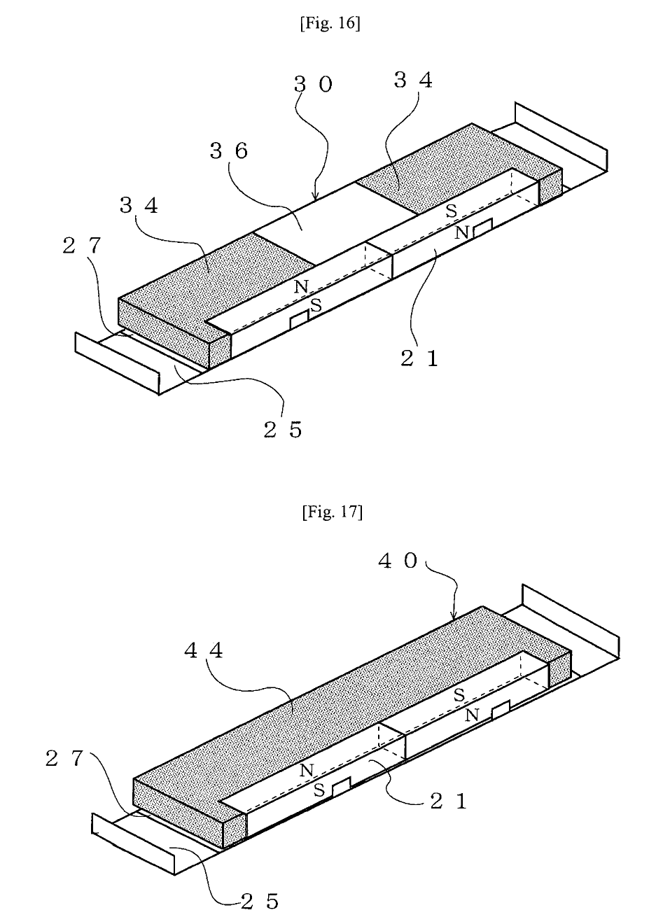

FIG. 16 is a perspective view of an oscillator 30 according to a second embodiment of the present invention. The same constituent elements of the second embodiment as those of the foregoing first embodiment are denoted by the same reference numerals as used in the first embodiment, and a redundant description thereof is omitted herein.

The oscillator 30 has a magnetic member 36 that is shorter and wider than the magnetic member 26 of the oscillator 20 in the first embodiment. The magnetic member 36 is sandwiched between a pair of weights 34. With this structure, the overall volume of the weights 34 is made larger than in the first embodiment to increase the mass of the oscillator 30.

FIG. 17 is a perspective view of an oscillator 40 according to a third embodiment of the present invention. The same constituent elements of the third embodiment as those of the foregoing first embodiment are denoted by the same reference numerals as used in the first embodiment, and a redundant description thereof is omitted herein.

The oscillator 40 has a weight 44 increased in volume at a portion thereof that retains the permanent magnet 21, and the weight of the oscillator 40 is increased.

The following is an explanation of a method of manufacturing an electromagnetic exciter according to the first embodiment. It should be noted that this manufacturing method is also applicable to electromagnetic exciters using oscillators structured as shown in FIGS. 16 and 17. The constituent elements of the following electromagnetic exciter have basically the same structures as those of the elements of the electromagnetic exciter according to the foregoing first embodiment. The drawings used in the following explanation additionally show square holes for snap-fit, notches, etc. needed to assemble the constituent elements of the electromagnetic exciter, which are not shown in FIGS. 1 to 18.

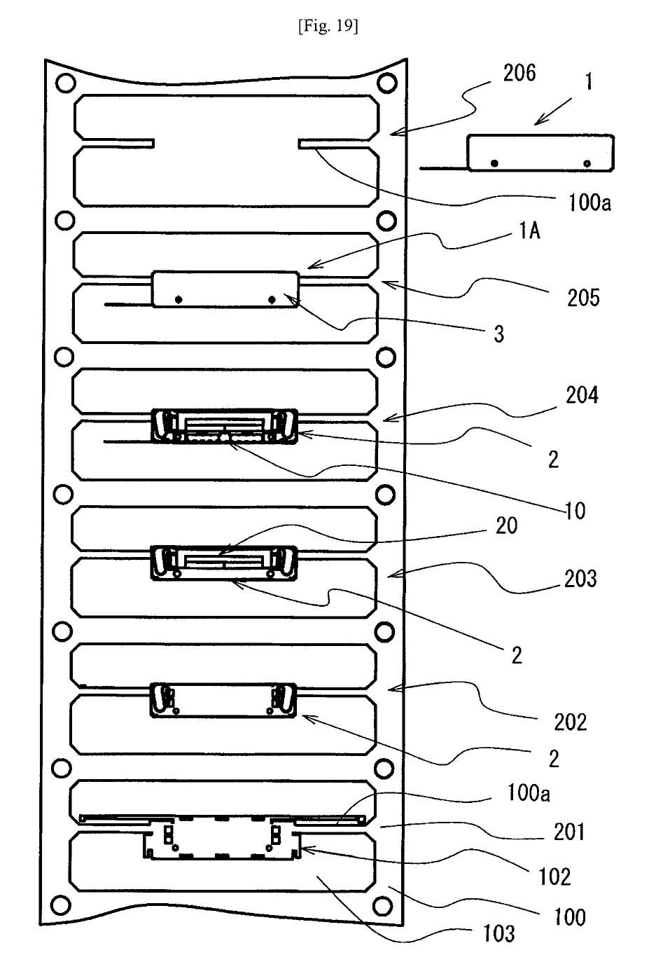

In the electromagnetic exciter manufacturing method according to this embodiment, as shown in FIG. 19, an electromagnetic exciter 1 is continuously manufactured while continuously feeding a metal strip material 100. The manufacturing method has an unfolded casing body blank forming step 201, a casing body forming step 202, an oscillator disposing step 203, a stator disposing step 204, a casing forming step 205, and a cutting step 206. In the unfolded casing body blank forming step 201, an unfolded casing body blank 102 for forming the above-described casing body 2 is formed by blanking a continuously fed strip material 100. The unfolded casing body blank 102 is held in a rectangular opening 103 by a pair of connecting strips 100a extending from the peripheral edge of the opening 103. In the casing body forming step 202, the outer peripheral portions of the unfolded casing body blank 102 are folded to form side wall portions, thereby forming a casing body 2. In the oscillator-disposing step 203, an oscillator 20 is disposed in the casing body 2 and fixed to the spring members 4a and 4b to support the oscillator 20. In the stator-disposing step 204, a stator 10 is disposed in the casing body 2 adjacently with the oscillator 20 and secured in this position. In the casing forming step 205, a cover 3 is fitted to the casing body 2 having the stator 10 and the oscillator 20 disposed therein, and the casing body 2 and the cover 3 are secured to each other to form a casing, and thus, the electromagnetic exciter 1 is completed. In the cutting step 206, the connecting strips 100a are cut off to separate the electromagnetic exciter 1 from the strip material 100. Thus, while the strip material 100 is continuously fed, the electromagnetic exciter is manufactured.

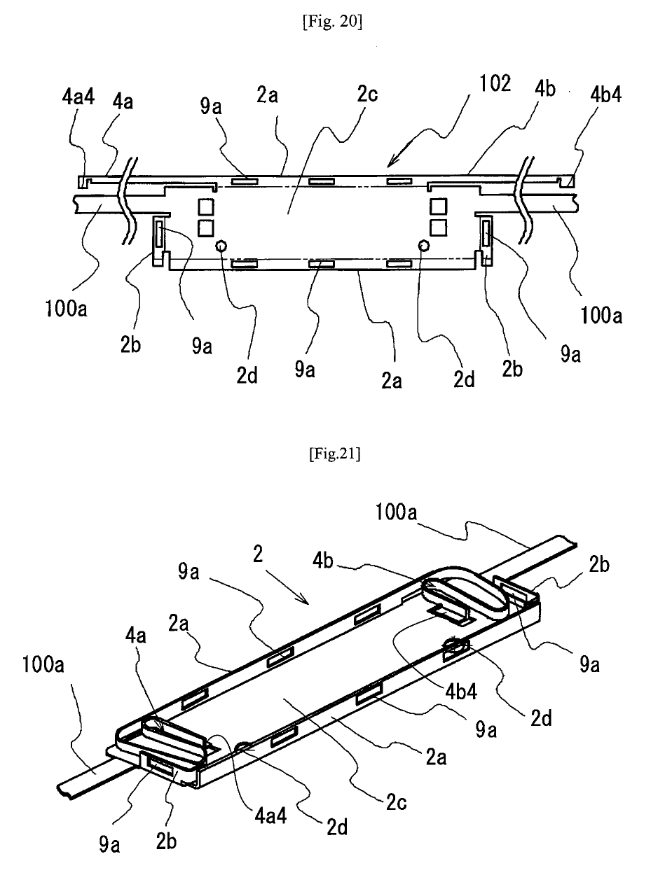

FIG. 20 shows the unfolded casing body blank 102 obtained by blanking the strip material 100 in the unfolded casing body blank forming step 201. The two-dotted chain lines show positions at which the unfolded casing body blank 102 is folded by forming process in the subsequent step. The side wall portions 2a and 2b of the casing body 2 have square holes 9a for snap-fitting to engage with the cover 3 to secure the casing body 2 thereto.

FIG. 21 is a perspective view showing the casing body 2 in the casing body forming step 202. As shown in FIG. 21, the casing body 2 is shaped into a box-like configuration by folding the unfolded casing body blank 102 in FIG. 20 at the positions shown by the two-dotted chain lines. The casing body 2 has a bottom wall portion 2c, long-side wall portions 2a and short-side wall portions 2d. A pair of spring members are formed by bending a pair of strip portions 4a and 4b shown in FIG. 20.

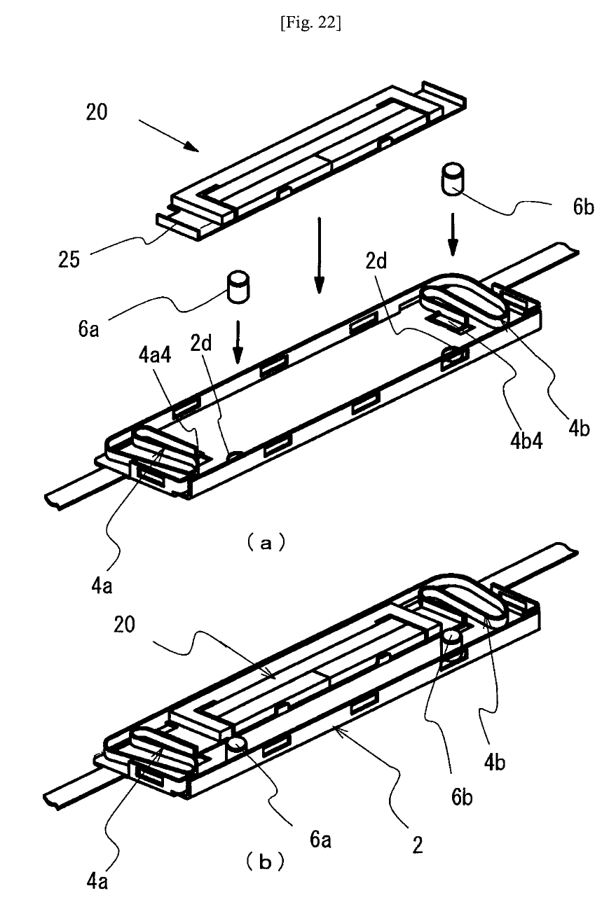

FIGS. 22 to 26 are drawings for explaining the oscillator-disposing step 203 at which the oscillator 20 is disposed in the casing body 2. As shown in FIG. 22, in the oscillator-disposing step 203, first, pins 6a and 6b are fitted and secured into a pair of first through-holes 2d provided in the casing body 2. The support plate 25 of the oscillator 20 is fixed at both ends thereof to the respective distal ends 4a4 and 4b4 of the spring members 4a and 4b of the casing body 2.

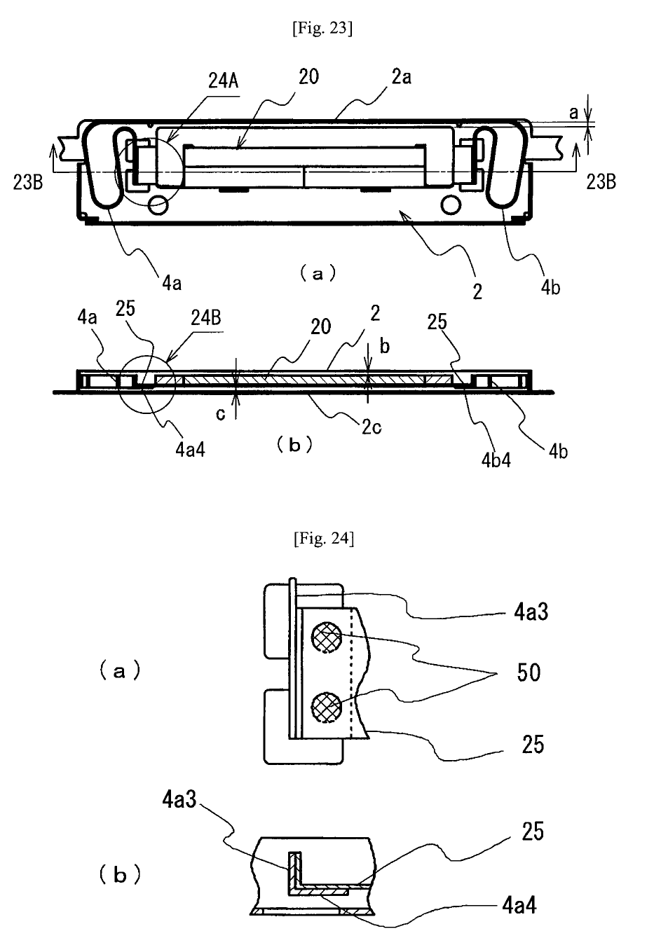

As shown in part (a) of FIG. 23, a predetermined gap a is provided between one long-side wall portion 2a of the casing body 2 and the oscillator 20. As shown in part (b) of FIG. 23, a predetermined gap b is provided between the upper end edge of the long-side wall portion 2a of the casing body 2 and the top of the oscillator 20, and a predetermined gap c is provided between the bottom wall portion 2c of the casing body 2 and the oscillator 20.

Part (a) of FIG. 24 is a fragmentary enlarged view of the part enclosed in the circle 24A in FIG. 23. Part (b) of FIG. 24 is a fragmentary enlarged view of the portion enclosed in the circle 24B in FIG. 23. FIG. 24 shows the way in which the support plate 25 of the oscillator 20 is fixed to the respective distal end portions 4a4 and 4b4 of the two spring members 4a and 4b. The distal end portion 4a4 of the spring member 4a is laser-welded to one end of the support plate 25 of the oscillator 20 at weld points 50. The distal end portion 4b4 of the spring member 5 is similarly welded to the other end of the support plate 25. The fixing method is not limited, but laser welding is preferable because no external force is applied to the members to be fixed to each other and thus the fixing operation can be performed stably.

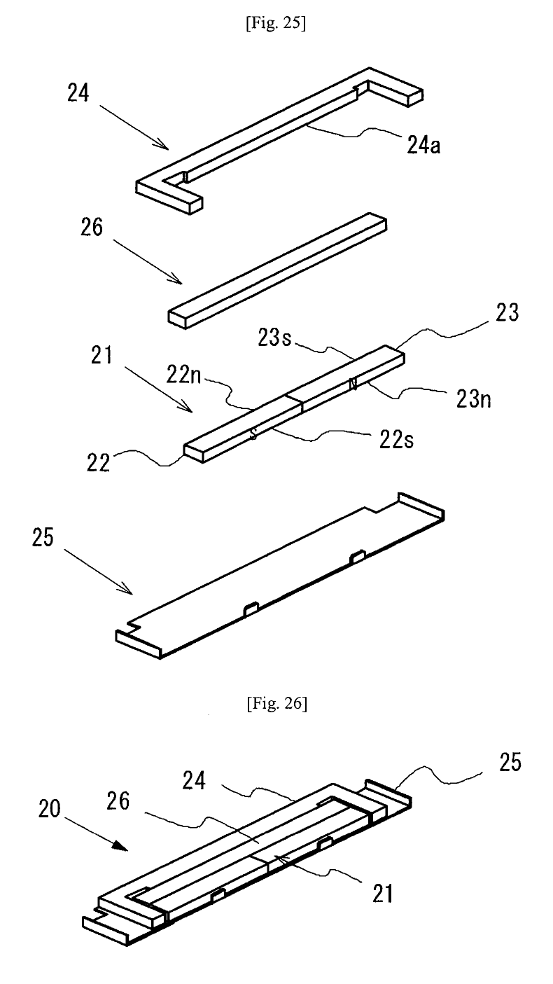

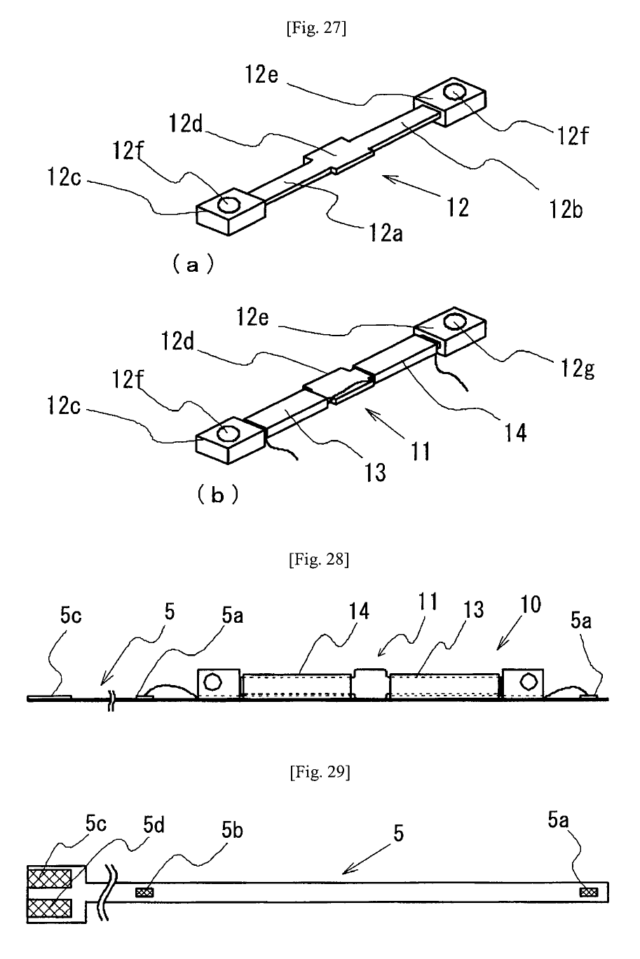

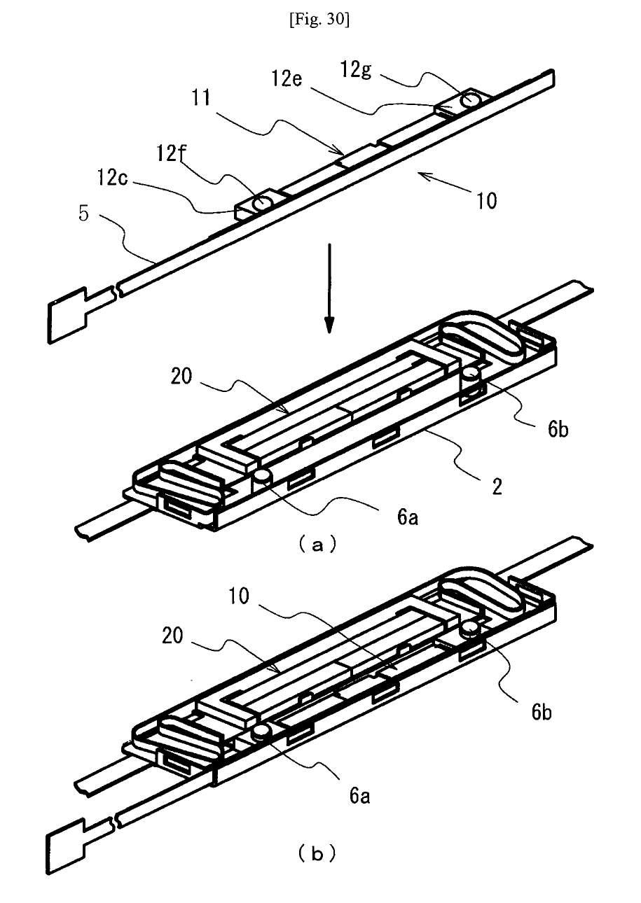

FIGS. 27 to 31 are drawings for explaining the stator-disposing step 204 of disposing the stator 20 shown in FIGS. 25 and 26. The stator 10 is disposed in the casing body 2 adjacently with the oscillator 10. The casing body 2 has the pins 6a and 6b disposed therein. In the stator-disposing step 204, the stator 10 is set in the casing body 2 by fitting through-holes 12f and 12g for positioning of the stator 10 with the pins 6a and 6b secured to the casing body 2.

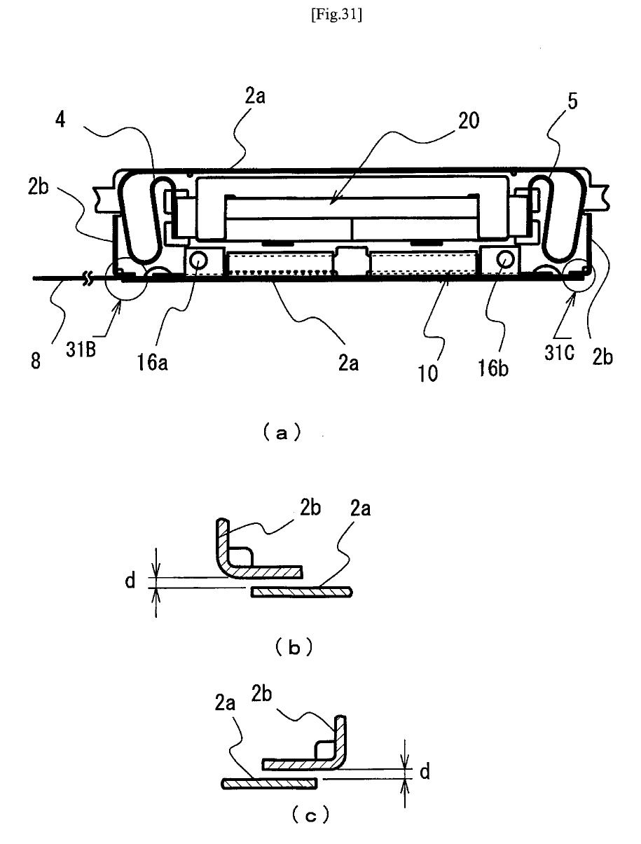

As shown in parts (b) and (c) of FIG. 31, the distal end portion of each short-side wall portion 2d of the casing body 2 is bent to extend along the long-side wall portion 2a at the corner of the casing body 2 to provide a gap d. The above-described FPC 5 is disposed inside the casing body 2 along the long-side wall portion 2a and extended to the outside through the gap d.

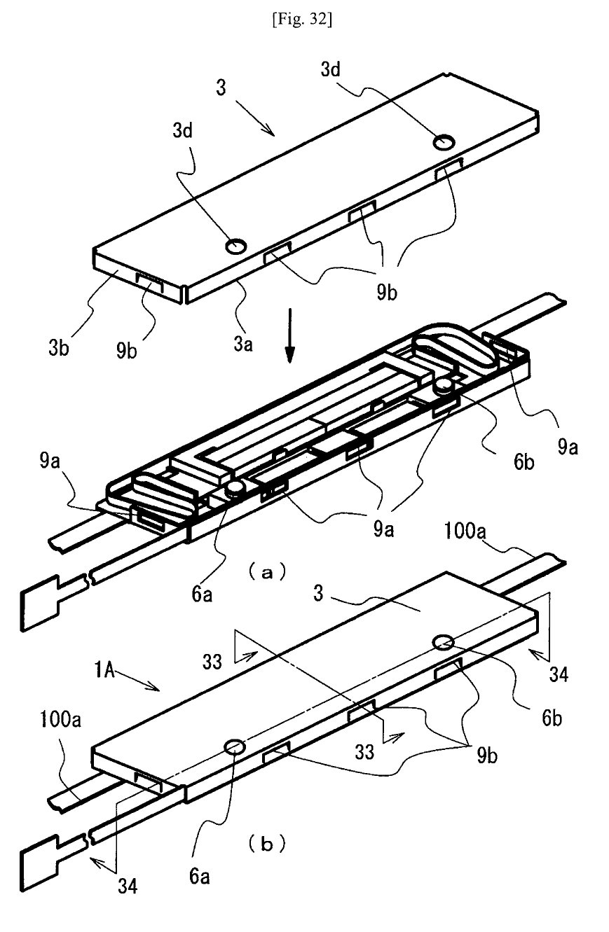

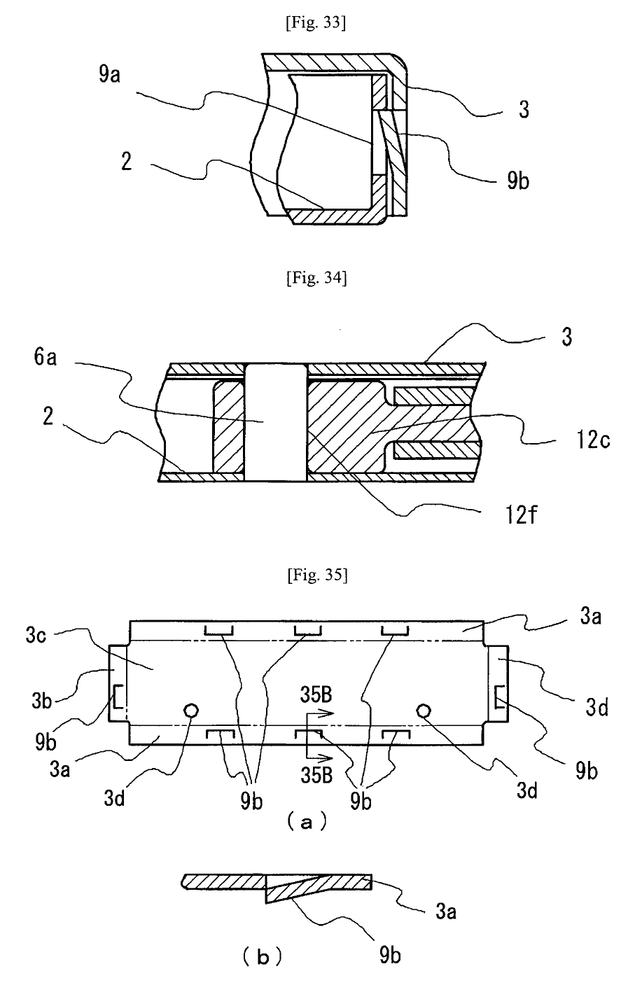

FIGS. 32 to 35 are drawings for explaining the casing forming step 205 at which the cover 3 is fitted and secured to the casing body 2 to form a casing. As shown in part (a) of FIG. 32, in the casing forming step 205, the cover 3 is fitted to the casing body 2 having the stator 10 and the oscillator 20 disposed therein adjacently, and hooks 9b for snap-fitting provided on the cover 3 are engaged in square holes 9a for snap-fitting provided in the casing body 2, and thus, the casing body 2 and the cover 3 are secured to each other to form a casing 1A shown in part (b) of FIG. 32. FIG. 33 is an enlarged sectional view of a part of a section taken along the line 33-33 in part (b) of FIG. 32, showing the way in which one hook 9b provided on the cover 3 is engaged in the associated square hole 9a provided in the casing body 2.

The pins 6a and 6b fitted to the stator 10 are fitted into second through-holes 3d, respectively, which are provided in the cover 3 to secure the stator 10. FIG. 34 is an enlarged sectional view of a part of a section taken along the line 34-34 in part (b) of FIG. 32, showing the way in which the stator 10 is secured to the cover 3 through the pin 6a.

FIG. 35 is a diagram showing the unfolded cover blank forming step. Part (a) of FIG. 35 shows a cover before being folded, i.e. an unfolded cover blank formed by blanking a metal plate material. Part (b) of FIG. 35 is an enlarged sectional view of a part of a section taken along the line 35B-35B in part (a) of FIG. 35, showing a hook 9b for snap-fit.

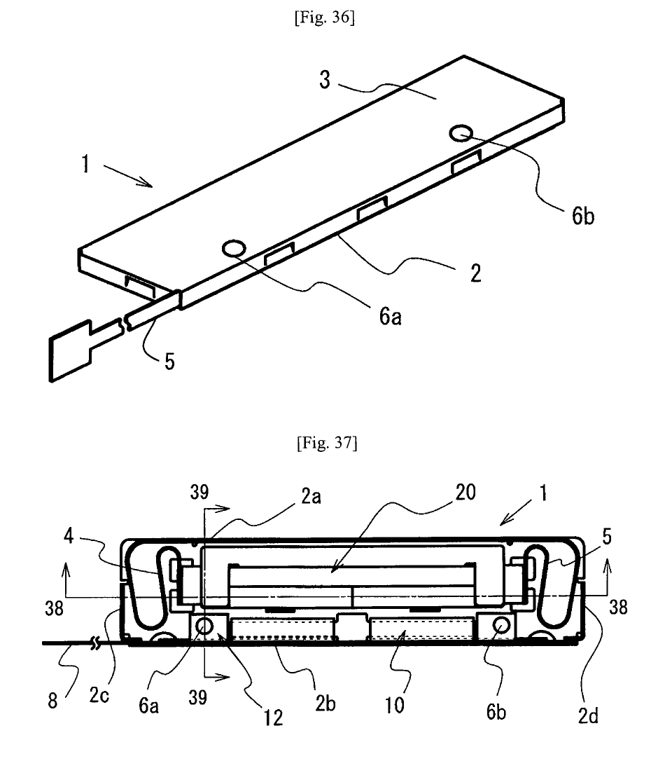

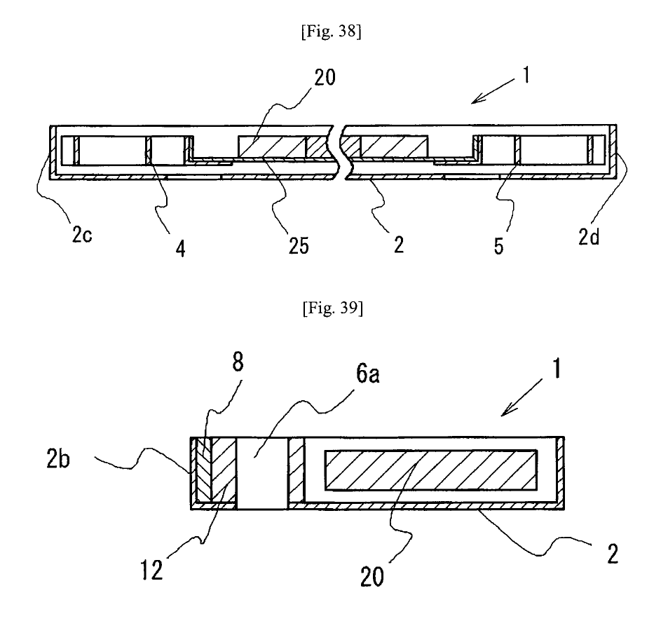

Finally, the connecting strips 100a are cut off to separate the casing 1A from the strip material 100 in the cutting step 206, and thus, an electromagnetic exciter 1 shown in FIG. 36 is completed. Thus, the electromagnetic exciter manufacturing method according to this embodiment enables the electromagnetic exciter 1 to be manufactured while continuously feeding the strip material 100.

The present invention is applicable not only to thin mobile devices such as mobile phones but also to vibration-generating devices, for example, used in touch panel type input devices to inform the user of an input confirmation by vibration.

1. An electromagnetic exciter comprising:
a casing having a flat bottom wall portion;
a stator having an electromagnet comprising a yoke and a coil wound around the yoke, the stator being secured to the bottom wall portion of the casing;
an oscillator having a permanent magnet and a weight attached to the permanent magnet; and
at least one resilient support member supporting the oscillator vibratably relative to the casing, the oscillator facing the bottom wall portion of the casing substantially parallel to a length direction of the casing and extending substantially parallel to the stator;
the oscillator being vibrated by an alternating magnetic field generated by application of an alternating current drive signal to the coil of the stator.

2. The electromagnetic exciter of claim 1, the casing further comprising:
a casing body having the bottom wall portion; and
a cover fitted to the casing body.

3. The electromagnetic exciter of claim 2, the at least one resilient support member including two resilient support members that support opposite ends, respectively, of the oscillator.

4. The electromagnetic exciter of claim 3, wherein the casing further comprises a casing body having the bottom wall portion and a side wall, a cover fitted to the casing body, and the two resilient support members are spring members each secured at one end thereof to the side wall of the casing body.

5. The electromagnetic exciter of claim 4, wherein the casing body is made of a metal, the spring members comprising two elongated metal plates extending from opposite ends, respectively, of the side wall of the casing body, the metal plates being serpentined inside the casing.

6. The electromagnetic exciter of claim 1, wherein the oscillator has a support plate that supports the oscillator, the support plate being supported substantially parallel to the bottom wall portion of the casing by the resilient support member.

7. The electromagnetic exciter of claim 6, wherein the oscillator has an adhesive layer disposed on the support plate, and the permanent magnet and the weight are disposed on the support plate.

8. The electromagnetic exciter of claim 7, wherein the oscillator has an adhesive sheet disposed on the support plate, and the permanent magnet and the weight are disposed on the support plate to be fixed to the support plate by the adhesive sheet.

9. The electromagnetic exciter of claim 6, wherein the casing body is made from a metal and has a side wall, the at least one resilient support member including a pair of spring members comprising a pair of strips extending from opposite ends of the side wall of the casing body, the strips being serpentined inside the casing body, and connected to opposite ends, respectively, of the support plate of the oscillator to support the oscillator.

10. The electromagnetic exciter of claim 5, wherein the cover has a side wall, the spring members extending from opposite ends, respectively, of the side wall of the casing body, the spring members being fixed to the side wall of the cover at respective positions away from the opposite ends toward distal ends of the spring members, an effective length of each of the spring members being defined by a length from each of the respective positions to the distal end of the corresponding spring member.

11. The electromagnetic exciter of claim 1, wherein the permanent magnet and the weight are arranged to constitute a single plate structure substantially parallel to the bottom wall portion of the casing.

12. The electromagnetic exciter of claim 1, wherein the yoke has a bar shape and is set parallel to the bottom wall portion of the casing body;
the coil of the stator having a first coil portion wound around the yoke at one side of a central portion of the yoke and a second coil portion wound around the yoke at the other side of the central portion, the yoke having magnetic pole portions at the central portion and end portions thereof, the magnetic pole portions at the end portions being arranged to generate a same magnetic pole, and the magnetic pole portion at the central portion being arranged to generate a magnetic pole opposite in polarity to the magnetic pole generated in the magnetic pole portions at the end portions;
the permanent magnet having a first permanent magnet and a second permanent magnet connected together in a straight line, the first permanent magnet and the second permanent magnet facing the first coil portion and the second coil portion, respectively, substantially parallel to the first and second coil portions, the first permanent magnet and the second permanent magnet having magnetic poles opposite in polarity to each other at their surfaces facing the first coil portion and the second coil portion, respectively.

13. A method of manufacturing an electromagnetic exciter having:
a casing body having a flat bottom wall portion;
a stator having an electromagnet comprising a yoke and a coil wound around the yoke, the stator being secured to the bottom wall portion of the casing body;
an oscillator having a permanent magnet and a weight attached to the permanent magnet; and
at least one resilient support member vibratably supporting the oscillator relative to the casing body, the oscillator facing the bottom wall portion of the casing body substantially parallel to a length direction of the bottom wall portion and extending substantially parallel to the stator;
the method comprising:
an unfolded casing body blank forming step of forming an unfolded casing body blank having a shape of the casing body as unfolded, the unfolded casing body blank being formed in each of openings formed in a strip material at predetermined intervals, the unfolded casing body blank being supported by connecting strips extending inward of the opening from a peripheral edge thereof;
a casing body forming step of forming the casing body in a shape of a tray by folding outer peripheral portions of the unfolded casing body blank to form the bottom wall portion and side wall portions surrounding the bottom wall portion;
an oscillator-disposing step of disposing the oscillator in the casing body substantially parallel to the bottom wall portion of the casing body at a distance from the bottom wall portion, the oscillator being vibratably supported by the at least one resilient support member;
a stator disposing step of disposing and securing the stator to the bottom wall portion of the casing body substantially parallel to the oscillator;
a casing forming step of fitting and securing a cover to the casing body having the stator and the oscillator disposed therein to complete the electromagnetic exciter; and
a cutting step of cutting off the connecting strips to separate the electromagnetic exciter from the strip material.

14. The method of claim 13, wherein the cover is formed by blanking a plate material into an unfolded cover blank having a shape of the cover as unfolded in a plane and folding outer peripheral portions of the unfolded cover blank to form a top wall portion and side wall portions surrounding the top wall portion, the cover being fitted and secured to the casing body with the side wall portions thereof contacting the side wall portions of the casing body.

15. The method of claim 13, wherein, in the unfolded casing body blank forming step, the unfolded casing body blank is formed with a pair of strip portions extending from opposite ends, respectively, of an outer peripheral edge portion of the unfolded casing body blank that is to form one of the side wall portions of the casing body, the pair of strip portions being serpentined inwardly to form a pair of resilient support members; and
in the oscillator disposing step, distal end portions of the pair of resilient support members are fixed to opposite ends, respectively, of the oscillator to support the oscillator.

16. The method of claim 13, wherein, in the unfolded casing body blank forming step, first through-holes for positioning the stator are formed in a portion of the unfolded casing body blank that is to form the bottom wall portion of the casing body; in the casing body forming step, pins are fitted and secured into the through-holes, respectively; in the stator-disposing step, the pins are fitted into through-holes for positioning provided in the stator to position the stator relative to the bottom wall portion of the casing body; and in the casing forming step, the pins are fitted into second through-holes for positioning the stator, which are provided in the cover, to secure the stator between the casing body and the cover.

17. The method of claim 13, wherein, in the unfolded casing body blank forming step, a plurality of snap-engaging portions are formed in portions of the unfolded casing body blank that are to form the side wall portions of the casing body, and in the casing forming step, the snap-engaging portions are engaged with snap-engaging portions formed on the side wall portions of the cover to secure the casing body and the cover to each other.

18. The method of claim 13, wherein the oscillator has a permanent magnet, a magnetic member and a weight of a high specific gravity material disposed on a single support plate in close contact with each other in a plane to form a plate-shaped structure as a whole.

19. The method of claim 13, wherein the yoke has a bar shape, the coil having a first coil portion wound around an end portion of the yoke at one side of a central portion of the yoke and a second coil portion wound around an end portion of the yoke at the other side of the central portion, the yoke having magnetic pole portions at the central portion and end portions of the yoke, the magnetic pole portions at the end portions being arranged to generate a same magnetic pole, and the magnetic pole portion at the central portion being arranged to generate a magnetic pole opposite in polarity to the magnetic pole generated in the magnetic pole portions at the end portions;
the permanent magnet having a first permanent magnet and a second permanent magnet connected together in a straight line, the first permanent magnet and the second permanent magnet facing the first coil portion and the second coil portion, respectively, substantially parallel to the first and second coil portions, the first permanent magnet and the second permanent magnet having magnetic poles opposite in polarity to each other at their surfaces facing the first coil portion and the second coil portion, respectively.

20. The method of claim 19, wherein the coil is formed by winding a single wire, the first coil portion and the second coil portion being opposite in winding direction but equal to each other in a number of turns of the wire.

21. A method of manufacturing an electromagnetic exciter having:
a flat casing including a casing body having a flat bottom wall portion and a cover fitted to the casing body;
a stator having an electromagnet comprising a yoke and a coil wound around the yoke, the stator being secured to the bottom wall portion of the casing body;
an oscillator having a permanent magnet and a weight attached to the permanent magnet; and
at least one spring member extending from the casing body to vibratably support the oscillator relative to the casing body, the oscillator facing the bottom wall portion of the casing body substantially parallel to a length direction of the casing body and extending substantially parallel to the stator;
the method comprising the steps of:
determining a spring constant of the at least one spring member so that a natural frequency of a vibration system comprising the at least one spring member and the oscillator in a state where the oscillator is supported by the at least one spring member is lower than a frequency of an alternating current drive signal applied to the electromagnet of the electromagnetic exciter;
measuring a natural frequency of the vibration system comprising the at least one spring member and the oscillator;
comparing the natural frequency measured to the frequency of the alternating current drive signal applied to the electromagnet to determine a length of the spring member necessary to make the natural frequency substantially equal to the frequency of the alternating current drive signal; and
making an adjustment to make an effective length of the spring member of the vibration system equal to the length of the spring member necessary by fixing, to the cover, a portion of the spring member at a position spaced apart from a proximal end of the spring member toward a distal end thereof.

22. The method of claim 21, wherein the at least one spring member includes a pair of spring members extending from opposite ends, respectively, of one of the side wall portions of the casing body, the pair of spring members supporting the oscillator at distal ends thereof.
